(19) United States
(12) Patent Application Publication
(10) Pub. No.: US 2015/0039772 A1
(43) Pub. Date: Feb. 5, 2015

(54) SUPL SESSION PERSISTENCE ACROSS POWER CYCLES

(71) Applicants: Murugan Natesan, Bangalore (IN); Pradeep Bangalore, Bangalore (IN); Chakradhara Panati, Bangalore (IN); Vivek Vachhani, Bangalore (IN)

(72) Inventors: Murugan Natesan, Bangalore (IN); Pradeep Bangalore, Bangalore (IN); Chakradhara Panati, Bangalore (IN); Vivek Vachhani, Bangalore (IN)

(21) Appl. No.: 14/127,797

(22) PCT Filed: Aug. 2, 2013
(86) PCT No.: PCT/US13/53464

§ 371 Date: Dec. 19, 2013

(51) Int. Cl. H04L 29/06

(52) U.S. Cl. CPC H04L 65/1066
USPC 709/227

(57) ABSTRACT

A method for managing a secure user plane location (SUPL)-enabled terminal (SET) to resume a SUPL trigger session after an interruption in the SUPL trigger session is described. The method may include initially configuring the SET for storing, periodically, a set of parameters defining a state of the SUPL trigger session and trigger parameters in a non-volatile storage of the SET, reading, after the interruption of the SUPL trigger session, the parameters defining a state of the SUPL trigger session and the trigger parameters from the non-volatile storage of the SET. The parameters defining a state of the SUPL trigger session and trigger session parameters stored in the non-volatile memory may then be used for restoring the SUPL trigger session.

### TECHNICAL FIELD

This disclosure relates generally to location information systems, and in particular, to secure user plane location (SUPL) architecture and methods.

### BACKGROUND ART

A standalone global positioning system (GPS) needs orbital information of the satellites to calculate a current position of a device (obtain a position fix). The data rate of the satellite signal is typically about 50 bits/s. Therefore, downloading of orbital information including, but not limited to, ephemeris and almanac, directly from the GPS satellites typically takes a long time. In poor signal conditions such as, for example, bad weather, presence of walls or tree cover, etc., if the satellite signal is lost during the acquisition of such data, the process to obtain a position fix starts from scratch. As such, a long time may be elapsed by the time (as long as 12 minutes in extremely poor conditions) a position fix is obtained.

Assisted GPS (A-GPS) may be used to alleviate the delays noted above by downloading the orbital information to a database on a server or network equipment stack, and providing the information to an electronic device connected to the server over relatively faster wireless signals such as, for example, GSM, GPRS, CDMA, LTE, WCDMA, WiFi and so forth. Secure User Plane Location (SUPL) is an Internet Protocol (IP) based protocol, defined by the Open Mobile Alliance (OMA) for A-GPS to receive information of GPS satellites as well as other assistance information such as reference time, reference location and so on, via IP from the server instead of slowly receiving over the GPS satellite signaling.

The SUPL architecture is generally composed of two elements: a SUPL Enabled Terminal (SET) and a SUPL Location Platform (SLP). The SET may be user equipment such as, for example, a phone, a PDA, or a laptop or tablet computer, which has been configured to support SUPL transactions. The SLP is a server or network equipment that handles tasks supported by SUPL including, but not limited to, user authentication, location requests, location-based applications, and so forth.

### BRIEF DESCRIPTION OF THE DRAWINGS

FIG. 1 depicts illustrative message exchange triggered session between a mobile device and SUPL server initiated by the mobile device in accordance with various aspects and principles of the present disclosure.

FIG. 2 depicts illustrative message exchange triggered session between a mobile device and SUPL server initiated by the SUPL Location Platform in accordance with various aspects and principles of the present disclosure.

FIG. 3 depicts information exchange within a mobile device in event of a trigger session is abruptly terminated when the mobile device losses power, in accordance with various aspects and principles of the present disclosure.

FIG. 4 depicts information exchange within a mobile device during trigger session restoration when power is restored to the mobile device, in accordance with various aspects and principles of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is disclosed is a method for managing a secure user plane location (SUPL)-enabled terminal (SET) to resume a SUPL trigger session after an interruption in the SUPL trigger session. The method may include initially configuring the SET for storing, periodically, a set of parameters defining a state of the SUPL trigger session and trigger parameters in a non-volatile storage of the SET, reading, after the interruption of the SUPL trigger session, the parameters defining a state of the SUPL trigger session and the trigger parameters from the non-volatile storage of the SET, and restoring the SUPL trigger session in response to reading the parameters defining a state of the SUPL trigger session and the trigger parameters.

In various embodiments, an electronic device may include a transceiver to transfer a location related information to a remote entity, a non-volatile storage, a processor, in communication with the transceiver and the non-volatile storage, configured to periodically store a set of parameters defining a state of a Secure User Plane Location (SUPL) trigger session and trigger parameters in the non-volatile storage, and to read, following an interruption in the SUPL trigger session, the parameters defining a state of the SUPL triggers session and the trigger parameters from the non-volatile storage for restoring and resuming the SUPL trigger session.

When a SUPL procedure starts in the network of a location information system, a SLP to which an external client is first connected is called a Requesting SLP (R-SLP). The R-SLP is a logical entity, which may be the same as a home SLP (H-SLP) or not. A SUPL Enabled Terminal, (SET), is aimed to track its current location is defined by a target SET.

The SLP, as a network element, may include an SUPL Positioning Center (SPC) which is an entity for calculating an actual location, and an SUPL Location Center (SLC) for managing other functions of the SLP excluding the function for calculating location information. Here, the SLC handles roaming, resource managing, and the like. Therefore, the SET can calculate the location information by communicating with the SPC via the SLC (Proxy mode), or calculate the location information by opening a direct connection with the SPC (Non-proxy mode).

A Triggered Location Service in the SUPL provides location information of a target SET when a specific condition (e.g. trigger event) occurs. The triggered location service may include a periodic triggered service which periodically provides location information of a target SET, and an area event triggered service which provides location information of a target SET whenever a specific area event occurs. In a triggered location service, a triggered session may be ongoing once it has been initiated unless a number of triggers have been met, a service time expires, or the triggered session is forcibly terminated. Once the triggered session is initiated, the session may last for a long period of time. However, an ongoing triggered session on a target SET may get abruptly terminated because of, for example, loss of power, or a system restart. In such cases, because the ongoing triggered session is unilaterally terminated, the service requesting party may have to request the triggered location service again from the network (the network performing the triggered location service) by re-providing trigger session parameters. As a result, the user experience suffers and there is a waste of network resources.

As such, various embodiments of the present disclosure describe seamless resumption of SUPL session without user intervention following an interruption in the SUPL session because of, for example, loss of power or a system crash. It is to be noted that embodiments described herein are illustrative and non-limiting and one skilled in the art will be able to conceive other embodiments in keeping with the scope of the present disclosure.

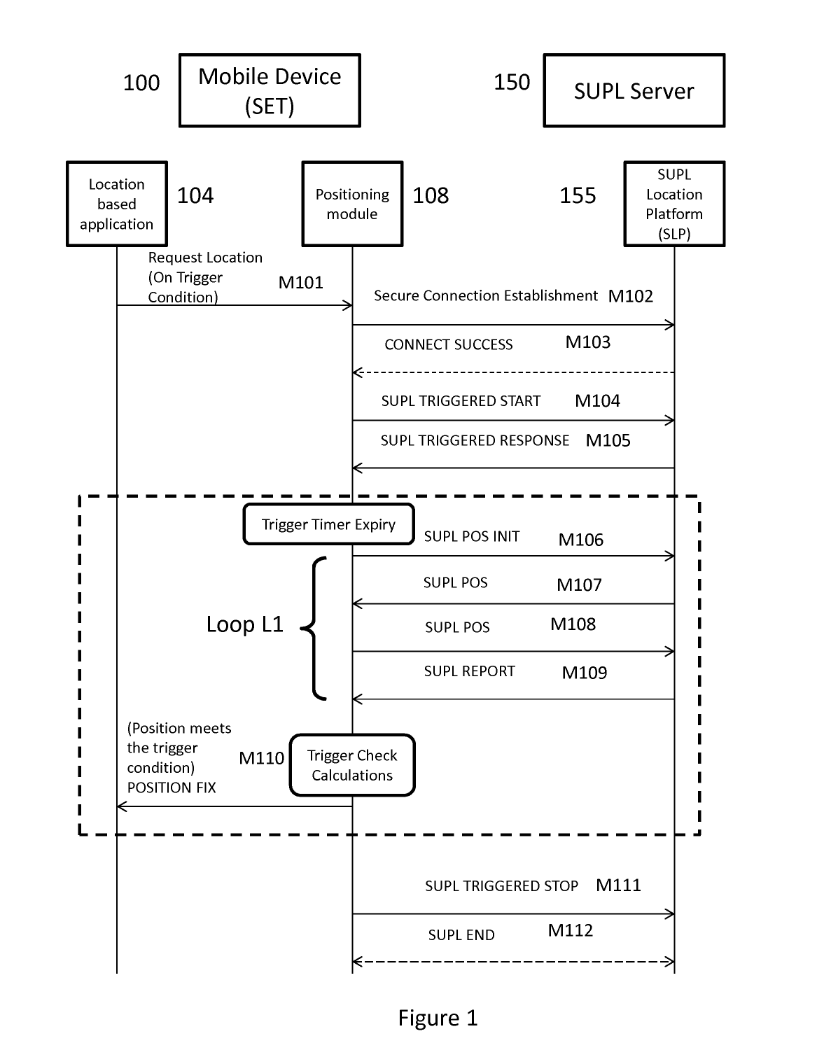

Described, using FIG. 1, is a message exchange triggered session between mobile device 100 and SUPL server 150 initiated by mobile device 100, in accordance with various aspects and principles of the present disclosure. Mobile device 100 includes, among other things, positioning module 108 which calculates the position of mobile device 100 using, positioning information obtained from SUPL location platform (SLP) 155 hosted on SUPL server 150, and location based application 104 which uses the position data provided by positioning module 108 for providing services to a user of mobile device 100.

When a user of mobile device 100 initiates a location-based application 104, location-based application 104 requests location data from positioning module 108 with message M101. Upon receiving request for location data M101, positioning module 108 establishes a secure connection with SLP 155 via message M102 which may respond using a connect success response M103. Positioning module 108 then initiates a trigger session using SUPL TRIGGERED START M104 message. In response, SLP 155 acknowledges the start of triggered session using SUPL TRIGGERED RESPONSE M105 message.

Once a triggered session is started, depending on the parameters defining a trigger condition such as, for example, start time, stop time, number and periodicity of requests, area event, etc., positioning module 108 requests positioning data from SLP 155 using message loop L1. The requested position data may include reporting of initial position of mobile device 100 to SUPL server 150 using SUPL POS INIT M106. This may be followed by exchange of location data between SLP 155 and positioning module 108 using SUPL POS M107 and SUPL POS M108 messages. Subsequently, SLP 155 sends SUPL REPORT M109 to mobile device 100. In various embodiments, message M109 may include the present position of mobile device 100 based on the positioning method.

Positioning module 108 then calculates a position fix at every instance of loop L1 execution. Message exchange of loop L1 may continue until one of the following three conditions is met: (a) the “Stop Timer” dictated by the SUPL protocol standard is reached; (b) a number of triggers met; or (c) the trigger session is abruptly terminated for any reason including, but not limited to, loss of connectivity between mobile device 100 and SUPL server 150, mobile device 100 losses power, operating system of mobile device 100 crashes, etc.

Positioning module 108 sends the position of mobile device 100 to location based application 104 using POSITION FIX M110 message whenever a trigger condition is met. However, under other circumstances including conditions (a) or (b), positioning module 108 sends a SUPL TRIGGERED STOP M111 message to SLP 155 indicating that location based application 104 intends to stop the triggered session. This may be followed by a SUPL END M112 acknowledgement exchange between positioning module 108 and SLP 155. SUPL END M112 message may be sent either by SLP 155 or positioning module 108.

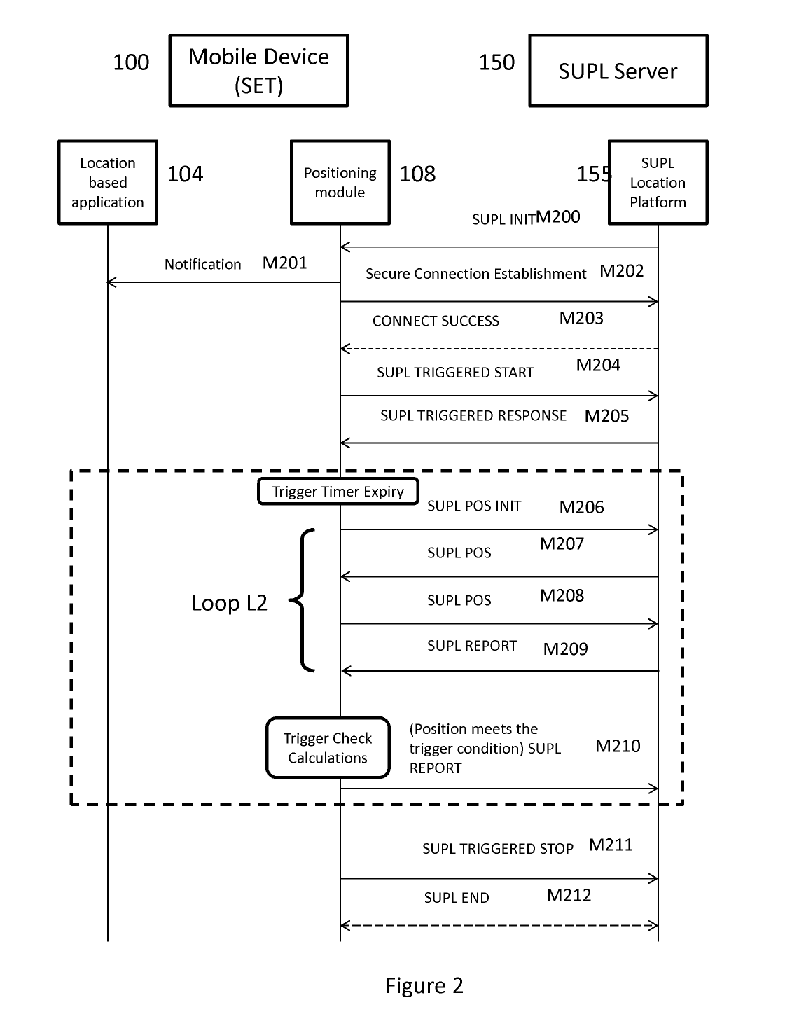

Described, using FIG. 2, is a message exchange triggered session between mobile device 100 and SUPL server 150 initiated by SLP 155, in accordance with various aspects and principles of the present disclosure.

As depicted, upon receiving SUPL INIT M200 from SLP 155, positioning module 108 notifies location based application 104 using Notification M201 message that SLP 155 has requested a triggered session. Positioning module 108 may then establish a secure connection with SLP 155 via message M202 which may, in turn, respond using a connect success response M203. Positioning module 108 then initiates a trigger session using SUPL TRIGGERED START M204 message. SLP 155 acknowledges the start of triggered session using SUPL TRIGGERED RESPONSE M205 message.

Once a triggered session is started, depending on the parameters defining a trigger condition such as, for example, start time, stop time, number and periodicity of requests, area event, etc., positioning module 108 requests positioning data from SLP 155 using message loop L2, which may include reporting of initial position of mobile device 100 to SUPL server 150 using SUPL POS INIT M206, exchange of location data between SLP 155 and positioning module 108 using SUPL POS M207 and SUPL POS M208, followed by SLP 155 reporting the present location to positioning module 108 using SUPL REPORT M209. Positioning module 108 may then calculate a position fix at every instance of loop L1 execution. Message exchange of loop L1 may continue until one of the following three conditions is met: (a) “Stop Timer” defined by the SUPL protocol standard reached; (b) a number of triggers occur; or (c) the trigger session is abruptly terminated for any reason including, but not limited to, loss of connectivity between mobile device 100 and SUPL server 150, mobile device 100 losses power, operating system of mobile device 100 crashes, etc.

Positioning module 108 sends the position of mobile device 100 to SLP 155 using SUPL REPORT M210 message. However, under other circumstances including conditions (a) or (b), positioning module 108 sends a SUPL TRIGGERED STOP M211 message to SLP 155 indicating that location based application 104 intends to stop the triggered session. This may subsequently be followed by a SUPL END M212 acknowledgement exchange between positioning module 108 and SLP 155. SUPL END M212 message may be sent either by SLP 155 or positioning module 108.

As already described, a trigger session may terminate abruptly for various reasons including, but not limited to, sudden loss of connectivity between mobile device 100 and SUPL server 150, loss of power at mobile device 100, operating system crash at mobile device 100, etc. In various embodiments, a trigger session may terminate abruptly during or between any message exchanges between mobile device 100 and SUPL server 150 as described herein. If a trigger session has not yet been fully established, for example, before loop L1 or loop L2 has started, or if a trigger session is about to end, for example, after a trigger condition is met (immediately before or any time after M110 or M210), mobile device 100 may decide, in some embodiments, to not restore the trigger session, for example, when power is restored at mobile device 100.

However, if a trigger session has been established and terminates abruptly during or between message exchanges of loop L1 or L2, the trigger session may be restored by providing positioning module 108 and SUPL server 150 with additional functionality.

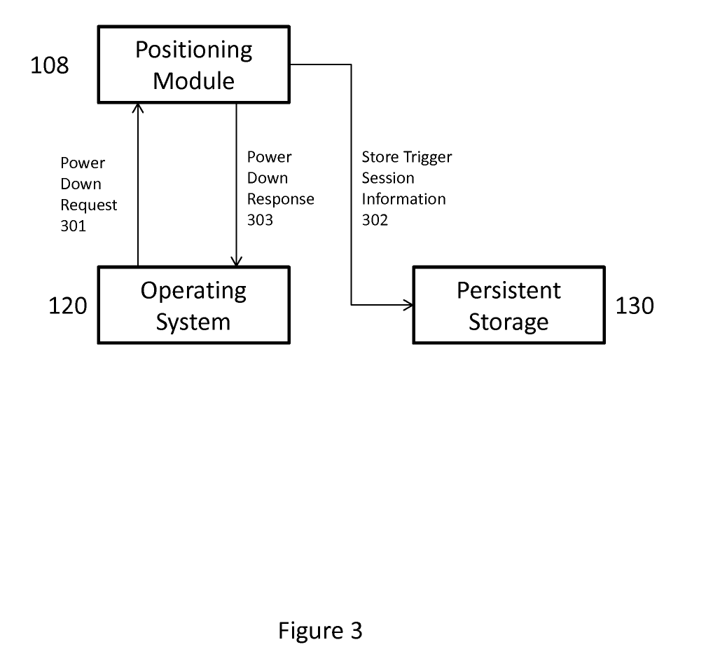

FIG. 3 depicts information exchange within the mobile device in event of a trigger session is abruptly terminated when the mobile device losses power, in accordance with various aspects and principles of the present disclosure. Apart from positioning module 108, mobile device 100 also may contain an operating system 120 and a persistent storage device 130. As depicted in FIG. 3, in the event of abrupt termination of a trigger session such as, for example, when power is lost at mobile device 100, operating system 120 may provide a power down request 301 to positioning module 108. Upon receiving the power down request 301, positioning module 108 stores trigger session information 302 including, but not limited to, parameters defining the trigger session, session identifier, session state information, number of reports sent, etc. to persistent storage 130 and notifies operating system 120 its readiness to the power down event using power down response 303.

In some embodiments, positioning module 108 may store trigger session information 302 to persistent storage 130 periodically and without any request from operating system 120. The periodicity with which positioning module 108 stores trigger session information 302 may be dictated, in various embodiments, either by a use of mobile device 100 or a built-in location-based application 104. In such embodiments, trigger session information may be made available to positioning module 108 in the event that the trigger session is terminated when operating system 120 does not have sufficient time to notify positioning module 108 about an impending termination.

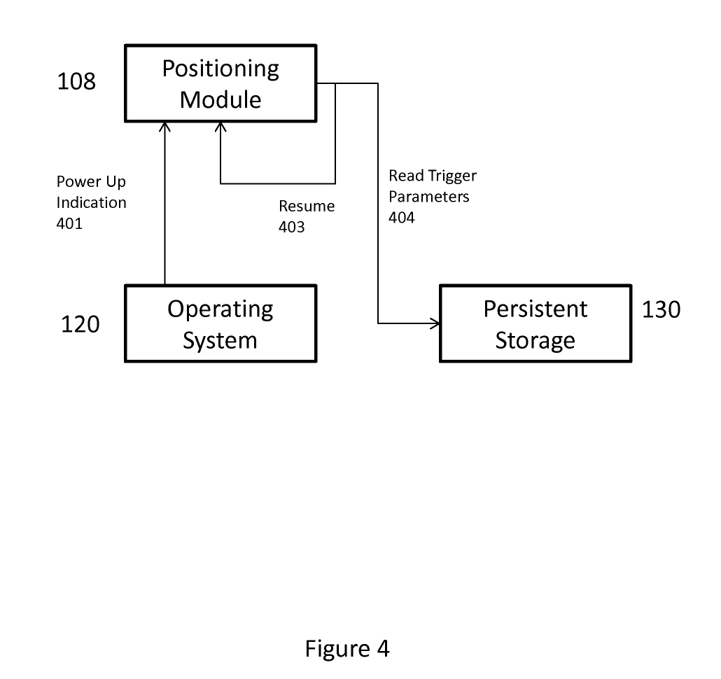

FIG. 4 depicts information exchange within the mobile device during trigger session restoration when power is restored to the mobile device, in accordance with various aspects and principles of the present disclosure. Upon receiving a power up indication 401 from operating system 120, positioning module 108 reads, at 402 triggered session information stored on persistent storage 130. Positioning module 108, then, uses this trigger session information to resume 403 the trigger session once mobile device 100 is able to connect with SLP 155.

In various embodiments, SLP 155 may request authentication information from mobile device 100 before restoring the trigger session for security and/or privacy reasons. Authentication information, in various embodiments, may include, for example user identifier, device identifier, a password or a PIN, etc.

When a trigger session started on mobile device 100 terminates abruptly, it is likely that SUPL server 150 may end the trigger session and purge or overwrite trigger session information from its storage any reason. In such cases, SUPL server 150 may not recognize the trigger session despite being restored by mobile device 100.

Therefore, in some embodiments, SUPL server 150 may be required to store trigger session information of any ongoing trigger session for a pre-defined period of time. In such embodiments, if mobile device 100 does not respond within an expected period of time, SUPL server 150 may treat an ongoing session as paused instead of terminated until the pre-defined period of time is elapsed. Trigger session information of a paused session may not be purged or overwritten by SUPL server 150. Accordingly, when mobile device 100 tries to restore the trigger session, SUPL server 150 can identify the trigger session, perform necessary validation and restore access to the session. The pre-defined period of time, in various embodiments, may be provided by a user of the mobile device, may be built into the location based application 104 of mobile device 100, may be built into the positioning module 108 to be conveyed to SUPL server 150 for each use-case, or may be codified in the SUPL protocol standard.

Another embodiment is implemented as a program product for implementing systems and methods described herein. Some embodiments can take the form of an entirely hardware embodiment, an entirely software embodiment, or an embodiment containing both hardware and software elements. Some embodiments may be implemented in software, which includes but is not limited to firmware, resident software, microcode, etc.

Furthermore, embodiments can take the form of a computer program product (or machine-accessible product) accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

Embodiments within the scope of the present disclosure may further include computer-readable media for carrying or having computer-executable instructions or data structures stored thereon. Such computer-readable media can be any available media that can be accessed by a general purpose or a special purpose computer. Such computer-readable media may include, but are not limited to, RAM, ROM, EEPROM, CD-ROM, or other optical disk storage, magnetic disk storage, or other magnetic storage devices, or any other medium which can be used to carry or store desired program code means in the form of computer-executable instructions or data structures. When information is transferred or provided over a network or another communications connection (either hardwired, wireless or a combination thereof) to a computer, the computer properly views the connection as a computer-readable medium. Thus, any such connection is properly termed as computer-readable medium. Combinations of the above should also be included within the scope of the computer-readable media.

Computer-executable instructions include, but are not limited to, instructions and data which cause a general purpose computer, a special purpose computer, or a special purpose processing device to perform a certain function or a group of functions. Computer-executable instructions also include program modules that are executed by computers in stand-alone or network environments. Generally, program modules include routines, programs, objects, components, data structures, and the like, that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, as the following claims reflect, inventive embodiments lie in less than all features of a single foregoing disclosed embodiment. Thus, the claims following the detailed description are hereby expressly incorporated into this detailed description.

### Examples

The following examples highlight non-limiting characteristics and attributes of the various and principles of the present disclosure:

Example 1 is a method for managing a secure user plane location (SUPL)-enabled terminal (SET) to resume a SUPL trigger session after an interruption in the SUPL trigger session. The method may include initially configuring the SET for: (i) storing, periodically, a set of parameters defining a state of the SUPL trigger session and trigger parameters in a non-volatile storage of the SET, (ii) reading, after the interruption of the SUPL trigger session, the parameters defining a state of the SUPL trigger session and the trigger parameters from the non-volatile storage of the SET, and (iii) restoring the SUPL trigger session in response to reading the parameters defining a state of the SUPL trigger session and the trigger parameters.

Example 2 is the method of example 1, wherein the interruption in the SUPL trigger session is caused by a loss of power to the SET.

Example 3 is the method of any one of examples 1-2, wherein the SUPL trigger session comprises a periodic trigger or an area event trigger.

Example 4 is the method of any one of examples 1-3, wherein the trigger parameters include one or more of the following: periodicity with which the SET reports its position to a SUPL location platform (SLP), number of times the SET reports its position to the SLP, start and/or stop times at which the SET reports its position the SLP, parameters defining a target area for which the SUPL trigger session is applicable, and parameters defining trigger event.

Example 5 is the method of example 4, wherein the parameters defining the target area for which the SUPL trigger session is applicable include one or more of the following: latitude, longitude and radius, range of latitude and longitude, postal location code, network cell ID(s), and name of a geographical location.

Example 6 is the method of example 4, wherein the trigger event includes one or more of the following occurrences: the SET entering, leaving, being inside, being outside the target area, or interval elapse.

Example 7 is the method of any one of examples 1-6, further comprising configuring the SET for authenticating a user prior to resuming the SUPL trigger session.

Example 8 is the method of any one of examples 1-7, further comprising configuring the SLP to store parameters defining a state of the SUPL trigger session for a period of time.

Example 9 is an electronic device including a transceiver to transfer a location related information to a remote entity; a non-volatile storage; a processor, in communication with the transceiver and the non-volatile storage, configured to periodically store a set of parameters defining a state of a Secure User Plane Location (SUPL) trigger session and trigger parameters in the non-volatile storage, and to read, following an interruption in the SUPL trigger session, the parameters defining a state of the SUPL triggers session and the trigger parameters from the non-volatile storage for restoring and resuming the SUPL trigger session.

Example 10 is the electronic device of example 9, wherein the interruption in the SUPL trigger session is caused by a loss of power to the electronic device.

Example 11 is the electronic device of any one of examples 9-10, wherein the SUPL trigger session comprises a periodic trigger or an area event trigger.

Example 12 is the electronic device of any one of examples 9-11, wherein the trigger parameters include one or more of the following: periodicity with which the electronic device reports its position to a SUPL location platform (SLP), number of times the electronic device reports its position to the SLP, start and/or stop times at which the electronic device reports its position the SLP, parameters defining a target area for which the SUPL trigger session is applicable, and parameters defining trigger event.

Example 13 is the electronic device of example 12, wherein the parameters defining the target area for which the SUPL trigger session is applicable include one or more of the following: latitude, longitude and radius; range of latitude and longitude; postal location code; network cell ID(s), and name of a geographical location.

Example 14 is the electronic device of example 12, wherein the trigger event includes one or more of the following occurrences: the SET entering, leaving, being inside, being outside the target area, or interval elapse.

Example 15 is the electronic device of any one of examples 9-14, further comprising configuring the SET for authenticating a user prior to resuming the SUPL trigger session.

Example 16 is the electronic device of any one of examples 9-15, further comprising configuring the SLP to store parameters defining a state of the SUPL trigger session for a period of time.

Example 17 is an electronic device comprising means for performing a method of any one of examples 1-8.

Example 18 is a system comprising means for performing a method of any one of examples 1-8.

Example 19 is a system comprising at least one electronic device comprising a processor, in communication with a memory, for executing instructions to perform a method of any one of examples 1-8.

Example 20 is a computer-readable medium comprising computer-readable code physically embodied thereon which, when executed by a processor, causes the processor to perform a method of any one of examples 1-8.

Example 21 is a computer-readable medium comprising computer-readable instructions to implement, when executed, the method of any one of examples 1-8.

Examples 22 is a computer program product comprising a computer-readable medium having computer program logic recorded thereon arranged to execute the method of any one of examples 1-8.

Example 23 is the method of example 1, wherein the SUPL trigger session comprises a periodic trigger or an area event trigger.

Example 24 is the method of example 1, wherein the trigger parameters include one or more of the following: periodicity with which the SET reports its position to a SUPL location platform (SLP), number of times the SET reports its position to the SLP, start and/or stop times at which the SET reports its position the SLP, parameters defining a target area for which the SUPL trigger session is applicable, and parameters defining trigger event.

Example 25 is the method of example 24, wherein the parameters defining the target area for which the SUPL trigger session is applicable include one or more of the following: latitude, longitude and radius, range of latitude and longitude, postal location code, network cell ID(s), and name of a geographical location.

Example 26 is the method of example 24, wherein the trigger event includes one or more of the following occurrences: the SET entering, leaving, being inside, being outside the target area, or interval elapse.

Example 27 is the method of example 1, further comprising configuring the SET for authenticating a user prior to resuming the SUPL trigger session.

Example 28 is the method of example 1, further comprising configuring the SLP to store parameters defining a state of the SUPL trigger session for a period of time.

Example 29 is the electronic device of example 9, wherein the interruption in the SUPL trigger session is caused by a loss of power to the electronic device.

Example 30 is the electronic device of example 9, wherein the SUPL trigger session comprises a periodic trigger or an area event trigger.

Example 31 is the electronic device of example 9, wherein the trigger parameters include one or more of the following: periodicity with which the electronic device reports its position to a SUPL location platform (SLP), number of times the electronic device reports its position to the SLP, start and/or stop times at which the electronic device reports its position the SLP, parameters defining a target area for which the SUPL trigger session is applicable, and parameters defining trigger event.

Example 32 is the electronic device of example 31, wherein the parameters defining the target area for which the SUPL trigger session is applicable include one or more of the following: latitude, longitude and radius; range of latitude and longitude; postal location code; network cell ID(s), and name of a geographical location.

Example 33 is the electronic device of example 31, wherein the trigger event includes one or more of the following occurrences: the SET entering, leaving, being inside, being outside the target area, or interval elapse.

Example 34 is the electronic device of example 9, further comprising configuring the SET for authenticating a user prior to resuming the SUPL trigger session.

Example 35 is the electronic device of example 9, further comprising configuring the SLP to store parameters defining a state of the SUPL trigger session for a period of time.

Example 36 is a computer-readable medium comprising computer-readable code physically embodied thereon which, when executed by a processor, causes the processor to perform a method of example 1.

Example 37 is a system comprising at least one electronic device comprising a processor, in communication with a memory, for executing instructions to perform a method of example 1.

1. A method for managing a secure user plane location (SUPL)-enabled terminal (SET) to resume a SUPL trigger session after an interruption in the SUPL trigger session, comprising:
initially configuring the SET for:
storing, periodically, a set of parameters defining a state of the SUPL trigger session and trigger parameters in a non-volatile storage of the SET;
reading, after the interruption of the SUPL trigger session, the parameters defining a state of the SUPL trigger session and the trigger parameters from the non-volatile storage of the SET; and
restoring the SUPL trigger session in response to reading the parameters defining a state of the SUPL trigger session and the trigger parameters.

2. The method of claim 1, wherein the interruption in the SUPL trigger session is caused by a loss of power to the SET.

3. The method of claim 1, wherein the SUPL trigger session comprises a periodic trigger or an area event trigger.

4. The method of claim 1, wherein the trigger parameters include one or more of the following: periodicity with which the SET reports its position to a SUPL location platform (SLP), number of times the SET reports its position to the SLP, start and/or stop times at which the SET reports its position the SLP, parameters defining a target area for which the SUPL trigger session is applicable, and parameters defining trigger event.

5. The method of claim 4, wherein the parameters defining the target area for which the SUPL trigger session is applicable include one or more of the following: latitude, longitude and radius, range of latitude and longitude, postal location code, network cell ID(s), and name of a geographical location.

6. The method of claim 4, wherein the trigger event includes one or more of the following occurrences: the SET entering, leaving, being inside, being outside the target area, or interval elapse.

7. The method of claim 1, further comprising configuring the SET for authenticating a user prior to resuming the SUPL trigger session.

8. The method of claim 1, further comprising configuring the SLP to store parameters defining a state of the SUPL trigger session for a period of time.

9. An electronic device comprising:
a transceiver to transfer a location related information to a remote entity;
a non-volatile storage;
a processor, in communication with the transceiver and the non-volatile storage, configured to periodically store a set of parameters defining a state of a Secure User Plane Location (SUPL) trigger session and trigger parameters in the non-volatile storage, and to read, following an interruption in the SUPL trigger session, the parameters defining a state of the SUPL triggers session and the trigger parameters from the non-volatile storage for restoring and resuming the SUPL trigger session.

10. The electronic device of claim 9, wherein the interruption in the SUPL trigger session is caused by a loss of power to the electronic device.

11. The electronic device of claim 9, wherein the SUPL trigger session comprises a periodic trigger or an area event trigger.

12. The electronic device of claim 9, wherein the trigger parameters include one or more of the following: periodicity with which the electronic device reports its position to a SUPL location platform (SLP), number of times the electronic device reports its position to the SLP, start and/or stop times at which the electronic device reports its position the SLP, parameters defining a target area for which the SUPL trigger session is applicable, and parameters defining trigger event.

13. The electronic device of claim 12, wherein the parameters defining the target area for which the SUPL trigger session is applicable include one or more of the following: latitude, longitude and radius; range of latitude and longitude; postal location code; network cell ID(s), and name of a geographical location.

14. The electronic device of claim 12, wherein the trigger event includes one or more of the following occurrences: the SET entering, leaving, being inside, being outside the target area, or interval elapse.

15. The electronic device of claim 9, further comprising configuring the SET for authenticating a user prior to resuming the SUPL trigger session.

16. The electronic device of claim 9, further comprising configuring the SLP to store parameters defining a state of the SUPL trigger session for a period of time.

17-18. (canceled)

19. A system comprising at least one electronic device comprising a processor, in communication with a memory, for executing instructions to perform a method of claim 1.

20. A computer-readable medium comprising computer-readable code physically embodied thereon which, when executed by a processor, causes the processor to perform a method of claim 1.

21-22. (canceled)
